(19) United States
(12) Patent Application Publication
(10) Pub. No.: US 2017/0286167 A1
(43) Pub. Date: Oct. 5, 2017

(54) TIME-BASED ADJUSTABLE LOAD BALANCING

(71) Applicant: Alibaba Group Holding Limited, Grand Cayman (KY)

(72) Inventor: Xiaoping Zhu, Beijing (CN)

(21) Appl. No.: 15/472,104

(22) Filed: Mar. 28, 2017

(30) Foreign Application Priority Data
Mar. 29, 2016 (CN) 201610188481.2

(51) Int. Cl. G06F 9/50

(52) U.S. Cl. CPC G06F 9/505; G06F 9/5044

(57) ABSTRACT

A time-based adjustable load balancing method and device is provided, which, by acquiring and recording at least one timed task including an execution time period and a load balancing method to be executed in the execution time period, implements creation of different load balancing methods based on definition of multiple time periods, and executes a corresponding load balancing method in an execution time period. Further, it is determined whether a current time enters an execution time period of one timed task, and if yes, the load balancing method corresponding to the timed task is acquired, and load balancing between multiple servers is processed based on the corresponding load balancing method, until the execution time period corresponding to the timed task ends, thereby implementing flexible configuration of a user. The load balancing method meeting the user requirement is flexibly applied to complicated user scenarios, thereby enhancing applicability of the load balancing.

### CROSS REFERENCE TO RELATED PATENT APPLICATIONS

This application claims priority to Chinese Patent Application No. 201610188481.2, filed on Mar. 29, 2016, entitled “TIME-BASED ADJUSTABLE LOAD BALANCING METHOD AND DEVICE,” which is hereby incorporated by reference in its entirety.

### TECHNICAL FIELD

The present disclosure relates to the field of computers, and in particular, to a technology for time-based adjustable load balancing.

### BACKGROUND

Currently, as business volumes increase, visitor volume and data traffic also quickly increase, and a single server cannot meet the requirements due to its bottleneck of processing capability. Therefore, a server cluster constructed by multiple servers is used, and a load balancing technology is introduced to effectively schedule resources and loads, to distribute a large amount of data traffic to the multiple servers in the cluster. In addition, a corresponding load balancing strategy is generated for a user to select for use.

The user may have some requirements when using the load balancing strategy. For example, the traffic of the user has an obvious time feature, such that the traffic is large during working time, while the traffic is small at night. If the charge is paid according to a fixed bandwidth, the traffic may not be totally used at night; and if the charge is paid according to the traffic, the cost may be very high in the case of a large amount of traffic. Another example includes a user wanting to have a big promotion in a time period requiring the bandwidth needing to be improved. However, after this time period, the bandwidth needs to be reverted back. If multiple users have requirements on big promotions in a time period, it is necessary to calculate in advance whether the capacity of load balancing can support the requirements. Configuration of load balancing strategies currently used by users are not flexible enough, and cannot pre-determine conditions of traffic used by the users.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

An objective of the present disclosure is to provide a time-based adjustable load balancing method and device, where different load balancing methods are created by defining various time periods, to implement flexible configuration of a user, and make a prejudgment on traffic used by the user.

According to one aspect of the present disclosure, a time-based adjustable load balancing method is provided, including:

acquiring and recording at least one timed task, wherein the timed task includes an execution time period and a load balancing method to be executed in the execution time period; and

determining whether a current time enters an execution time period of one timed task, and if yes, acquiring the load balancing method corresponding to the timed task, and processing load balancing between multiple servers based on the corresponding load balancing method, till the execution time period corresponding to the timed task ends.

Further, the acquiring and recording at least one timed task includes:

acquiring a user request, wherein the user request includes a request time period and a load balancing method to be executed in the request time period; generating at least one timed task based on the user request, and determining an execution time period of the timed task based on the request time period; and determining, based on the user request, a load balancing method to be executed in the execution time period.

For example, the determining, based on the user request, the load balancing method to be executed in the execution time period includes:

acquiring performance parameter information of load balancing based on the user request; and determining, based on the performance parameter information of load balancing, the load balancing method to be executed in the execution time period.

For example, the performance parameter information includes at least one of the following: a bandwidth amount; a number of creatable connections; and a number of new creatable connections per second.

For example, the determining, based on the user request, the load balancing method to be executed in the execution time period includes:

stopping generating the timed task when the acquired performance parameter information of load balancing exceeds performance parameter information of existing service capability of the load balancing, and returning alarm notification information.

For example, the acquiring the timed task further includes:

updating the execution time period of the timed task based on an overlapped time period when the request time period and the execution time period have the overlapped time period; and updating the timed task based on the updated execution time period.

For example, the time-based adjustable load balancing method further includes deleting the load balancing method and acquiring a next load balancing method corresponding to a next execution time period, when the execution time period corresponding to the timed task ends.

For example, the timed task includes any of the following:

a first timed task executed periodically and circularly;

a second timed task executed once; and

a third timed task coordinating the first timed task executed once with the second timed task executed periodically and circularly.

According to another aspect of the present disclosure, a time-based adjustable load balancing device is provided, including:

an acquisition apparatus that acquires and record at least one timed task, wherein the timed task includes an execution time period and a load balancing method to be executed in the execution time period; and

an execution apparatus that determines whether a current time enters an execution time period of one timed task, and if yes, acquire the load balancing method corresponding to the timed task, and process load balancing between multiple servers based on the corresponding load balancing method, till the execution time period corresponding to the timed task ends.

Further, the acquisition apparatus includes:

a request acquisition unit that acquires a user request, wherein the user request includes a request time period and a load balancing method to be executed in the request time period;

a generation unit that generates at least one timed task based on the user request, and determine an execution time period of the timed task based on the request time period; and

a determination unit that determines, based on the user request, a load balancing method to be executed in the execution time period.

For example, the determination unit further:

acquires performance parameter information of load balancing based on the user request; and determines, based on the performance parameter information of load balancing, the load balancing method to be executed in the execution time period.

For example, the performance parameter information includes at least one of the following:

a bandwidth amount;

a number of creatable connections; and

a number of new creatable connections per second.

For example, the determination unit further:

stops generating the timed task when the acquired performance parameter information of load balancing exceeds performance parameter information of existing service capability of the load balancing, and returns alarm notification information.

For example, the acquisition apparatus includes:

a first update unit that updates the execution time period of the existing timed task based on the overlapped time period when the request time period and the execution time period of the existing timed task have an overlapped time period.

For example, the acquisition apparatus further includes:

a second update unit that updates the existing timed task based on the updated execution time period, wherein the timed task is a timed task executed once or a timed task executed periodically and circularly.

For example, the execution apparatus further deletes the load balancing method and acquiring a next load balancing method corresponding to a next execution time period, when the execution time period corresponding to the timed task ends.

For example, the timed task comprises any of the following:

a first timed task executed periodically and circularly;

a second timed task executed once; and

a third timed task coordinating the first timed task executed once with the second timed task executed periodically and circularly.

According to another aspect of the present disclosure, one or more memories stored thereon computer-executable instructions that, when executed by one or more processors, cause the processor to perform acts comprising:

acquiring a timed task, the timed task including an execution time period and a load balancing method to be executed in the execution time period;

determining that a current time enters into the execution time period;

acquiring the load balancing method corresponding to the timed task; and

processing load balancing between multiple servers based on the load balancing method corresponding to the timed task until the execution time period corresponding to the timed task ends.

Compared with the conventional techniques, the time-based adjustable load balancing method and device according to the example embodiments of the present disclosure acquire and record at least one timed task, wherein the timed task includes an execution time period and a load balancing method to be executed in the execution time period; acquire performance parameter information of load balancing based on a user request; then, determine, based on the performance parameter information of load balancing, a load balancing method to be executed in the execution time period. Therefore, different load balancing methods are created by defining multiple time periods, and a corresponding load balancing method is executed in an execution time period. Further, it is determined whether a current time enters an execution time period of one timed task, and if yes, the load balancing method corresponding to the timed task is acquired, and load balancing between multiple servers is processed based on the corresponding load balancing method, till the execution time period corresponding to the timed task ends, thereby implementing flexible configuration of the user. The load balancing method meeting the user requirement is flexibly applied to complicated user scenarios, thereby enhancing the applicability of the load balancing.

### BRIEF DESCRIPTION OF THE DRAWINGS

The features, objectives, and advantages of the present disclosure will become more evident by reference to detailed description of non-restrictive example embodiments accompanying the following drawings:

FIG. 1 is a schematic structural diagram of a time-based adjustable load balancing device according to one aspect of the present disclosure;

FIG. 2 is a schematic structural diagram of an acquisition apparatus 110 in an example embodiment according to one aspect of the present disclosure;

FIG. 3(a) shows an existing timed task and a strategy in a corresponding time period;

FIG. 3(b) is a schematic diagram of an example embodiment of updating a timed task according to one aspect of the present disclosure;

FIG. 4 is a schematic flow chart of a time-based adjustable load balancing method according to another aspect of the present disclosure; and

FIG. 5 is a schematic flow chart of a method of step 5402 in an example embodiment according to another aspect of the present disclosure.

Identical or similar reference numerals in the accompanying drawings represent identical or similar components.

### DETAILED DESCRIPTION

The present disclosure is further described below in detail with reference to the accompanying drawings.

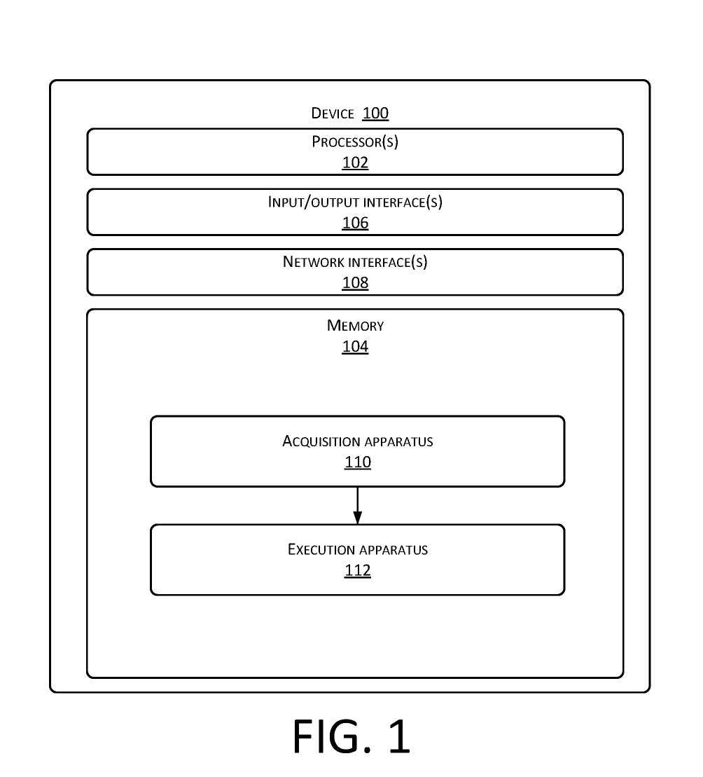

FIG. 1 is a schematic structural diagram of a time-based adjustable load balancing device according to an aspect of the present disclosure. A device 100 includes one or more processor(s) 102 or data processing unit(s) and memory 104. The device 100 may further include one or more input/output interface(s) 106, and network interface(s) 108. The memory 104 is an example of computer readable media.

The computer readable media include volatile and non-volatile, removable and non-removable media, and can use any method or technology to store information. The information may be a computer readable instruction, a data structure, and a module of a program or other data. Examples of storage media of a computer include, but are not limited to, a phase change memory (PRAM), a static random access memory (SRAM), a dynamic random access memory (DRAM), other types of RAMs, an ROM, an electrically erasable programmable read-only memory (EEPROM), a flash memory or other memory technologies, a compact disk read-only memory (CD-ROM), a digital versatile disc (DVD) or other optical storage, a cassette tape, a tape disk storage or other magnetic storage devices, or any other non-transmission media, which can be that storing information accessible to a computation device. According to the definition herein, the computer readable media does not include transitory computer readable media (transitory media), for example, a modulated data signal and a carrier.

The memory 104 may store therein a plurality of modules or units including an acquisition apparatus 110 and an execution apparatus 112. The acquisition apparatus 110 acquires and records at least one timed task, wherein the timed task includes an execution time period and a load balancing method to be executed in the execution time period. The execution apparatus 112 determines whether a current time enters an execution time period of one timed task, and if yes, acquires the load balancing method corresponding to the timed task, and processes load balancing between multiple servers based on the corresponding load balancing method, till the execution time period corresponding to the timed task ends.

Herein, the device 100 may include, but is not limited to including, user equipment, or a device constructed by integrating user equipment and a network device via a network. The user equipment may include, but is not limited to including, any mobile electronic product that can perform man-machine interaction with a user through a touch pad, such as a smart phone and a PDA. The mobile electronic product may use any operating system, such as an android operating system and an iOS operating system. Wherein, the network device includes an electronic device capable of automatically performing numerical calculation and information processing according to a preset or pre-stored instruction, and hardware thereof includes, but is not limited to, a microprocessor, an application specific integrated circuit (ASIC), a field programmable gate array (FPGA), a digital signal processor (DSP), an embedded device, and the like. The network includes, but is not limited to, the Internet, a wide area network, a metropolitan area network, a local area network, a VPN network, a wireless Ad Hoc network, and the like. For example, the device 100 may also be a script program run on the user equipment, or user equipment and a network device, a touch terminal, or a device that is formed by the network device integrated with the touch terminal through the network. Definitely, those skilled in the art should understand that the device 100 is merely an example, and other existing or future possible devices 100, if applicable to the present disclosure, should also be included in the protection scope of the present disclosure, and be incorporated herein by reference.

The operations of the foregoing apparatuses are continuous, and herein, those skilled in the art should understand that the wording “continuous” means that the foregoing apparatuses separately operate in real time or according to requirements of a preset or real-time adjusted operation mode. For example, the acquisition apparatus 110 continuously acquires and records at least one timed task; and the execution apparatus 112 continuously determines whether a current time enters an execution time period of one timed task, and if yes, acquires the load balancing method corresponding to the timed task, and processes load balancing between multiple servers based on the corresponding load balancing method, till the execution time period corresponding to the timed task ends, and till the device 100 completes the load balancing adjustment work or stops working.

The device 100 for time-based adjustable load balancing according to an example embodiment of the present disclosure enables a corresponding load balancing method to be executed in an execution time period of a request according to the request of a user, thereby implementing flexible configuration of the user to meet the requirement of the user, and meanwhile increasing the applicability of load balancing.

Those skilled in the art should understand that, in a specific solution implementation, the load balancing strategy is used to select, according to an access request of the user, a back-end server according to a correspondingly made load balancing strategy to process the request, and for ease of description, the load balancing method and the load balancing strategy (SLB strategy) are exchanged for use in the example embodiment.

Specifically, the acquisition apparatus 110 acquires and records at least one timed task, wherein the timed task includes an execution time period and a load balancing method to be executed in the execution time period.

Herein, a Server Load Balancer (SLB) is a load balancing service for distributing traffic for multiple cloud servers, and the load balancing may extend external service capability of an application system by traffic distribution, and improve the usability of the application system by eliminating single point of failure. In an example embodiment of the present disclosure, the SLB controller delivers the SLB strategy to an SLB forwarding server. To implement a time-based strategy, a time server needs to be created on the SLB controller, all strategies relevant to time may be sent to the time server, and the time server delivers a corresponding forwarding strategy to the forwarding server according to the time strategy. It should be noted that, in the above example embodiment, the acquisition apparatus 110 may include a time server, and the time server implements a timed task executed once and a timed task executed circularly, wherein the timed task is executing, in a time period, a to-be-executed load balancing strategy selected by the user. At least one timed task is generated by acquiring time period information of the user request and information of SLB strategy to be executed in the time period, and a corresponding SLB strategy is executed in the time period of the request based on the timed task. For example, the user selects, according to a traffic use condition thereof, an SLB strategy a 302 in a time period from 06:00 to 18:00, selects an SLB strategy b 304 in a time period from 18:00 to 06:00 of the next day, request information of the selected time period and information of the SLB strategy executed in the corresponding time period are sent to the time server, and two timed tasks are generated. A timed task a is used for the time server to execute the SLB strategy a 302 in the time period from 06:00 to 18:00, and the timed task b is used for the time server to execute the SLB strategy b 304 in the time period from 18:00 to 06:00 of the next day.

Those skilled in the art should understand that the method of acquiring and recording a timed task is merely an example, and other existing or future possible methods of acquiring and recording a timed task, if applicable to the present disclosure, should also be included in the protection scope of the present disclosure, and be incorporated herein by reference.

Specifically, the execution apparatus 112 determines whether a current time enters an execution time period of one timed task, and if yes, acquires the load balancing method corresponding to the timed task, and processes load balancing between multiple servers based on the corresponding load balancing method, till the execution time period corresponding to the timed task ends.

According to the foregoing example, after the user selects, according to the traffic use condition thereof, the SLB strategy a in the time period from 06:00 to 18:00 and selects the SLB strategy b in the time period from 18:00 to 06:00 of the next day, the time server acquires the request information of the time period selected by the user and information of the SLB strategy executed in the corresponding time period, forwards the acquired information to the forwarding server according to the forwarding strategy, thereby implementing load balancing between multiple servers. When multiple timed tasks are executed, it is needed to determine whether the current time enters a selected time period, and if the current time belongs to the time period from 6:00 to 18:00, the SLB strategy a is executed and ends at the time point 18:00, then the next time period from 18:00 to 06:00 of the next day is entered, and the SLB strategy b is always executed in this time period till the timed task b corresponding to the time period ends.

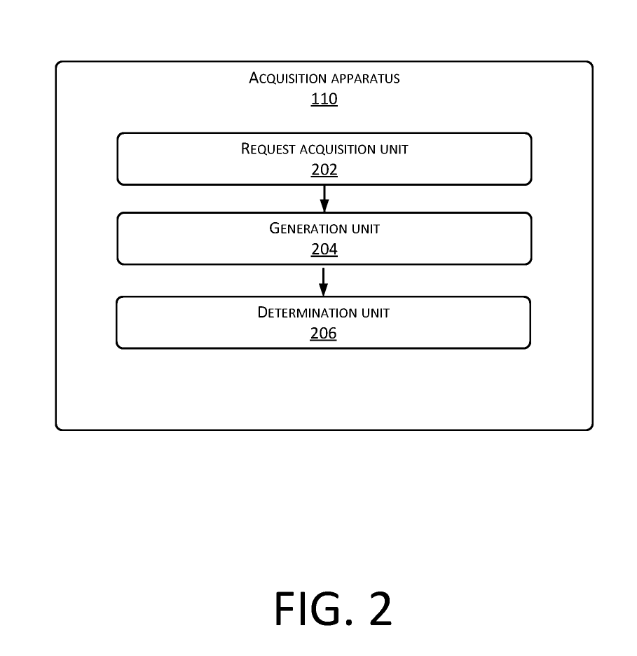

For example, FIG. 2 is a schematic structural diagram of an acquisition apparatus 110 in an example embodiment according to one aspect of the present disclosure. In the example of FIG. 2, the acquisition apparatus 110 includes: a request acquisition unit 202, a generation unit 204, and a determination unit 206. Wherein, the request acquisition unit 202 acquires a user request, wherein the user request includes a request time period and a load balancing method to be executed in the request time period; the generation unit 204 generates at least one timed task based on the user request, and determines an execution time period of the timed task based on the request time period; and the determination unit 206 determines, based on the user request, a load balancing method to be executed in the execution time period.

In a specific example embodiment, the request acquisition unit 202 acquires information of the time period selected by the user and information of an SLB strategy to be used in the time period, the generation unit 204 generates a corresponding timed task according to the acquired request information, and determines a time period of executing the timed task; then, the determination unit 206 determines that the SLB strategy needed by the user is executed in the execution time period, that is, a corresponding SLB strategy is executed in each time period, an SLB strategy is added when time of the time period starts, the SLB strategy is deleted when the time point ends, and a new strategy is added again when the next time period is entered and then is executed, such that flexible configuration of the user is completed according to the requirement of the user.

For example, the determination unit 206 determines, based on the user request, performance parameter information of load balancing; then, determine, based on the performance parameter information of load balancing, a load balancing method to be executed in the execution time period.

For example, the performance parameter information includes at least one of the following: bandwidth amount, the number of creatable connections, and the number of new creatable connections per second. For example, the user wants promotion in a month, and requires that the bandwidth is increased in this month, the required bandwidth is changed to B from the previous A, according to the request of the user, it is determined that an SLB strategy of distributing bandwidth B to the user in this month and distributing the bandwidth A in the time period of other months is executed; for another example, a server of an enterprise needs to adjust, in a time period, the number of personal computers (PCs) that can create connections, and an SLB strategy in the required time period is determined according to the request of the number of creatable connections. Alternatively, a corresponding adjusted SLB strategy is determined according to the request of the number of new creatable connections per second required by the server. It should be noted that, the bandwidth amount, the number of creatable connections, and the number of new creatable connections per second are resources provided by the load balancing to the external, and may be used as SLB performance parameters owned by the user. Resources distributed by the load balancing to the user server are adjusted by the SLB strategy created based on time, thus meeting the requirement of the user for using the SLB. For example, the bandwidth is increased when the traffic of the user is large, and the bandwidth is decreased when the traffic of the user is small, and such a flexible strategy saves cost of the user.

For example, the determination unit 206 further, when the acquired performance parameter information of load balancing exceeds performance parameter information of existing service capability of the load balancing, stops generating the timed task, and returns alarm notification information.

Herein, determining the service capability of the load balancing is based on the capacity of the forwarding server and a service capability referenced by the strategy of executing the timed task. For example, the performance parameters such as bandwidth, the number of creatable connections, and the number of new creatable connections per second. If a sum of service capabilities referenced by SLB strategies selected by all users exceeds the capacity of the forwarding server, an alarm is given to notify an administrator of taking a corresponding measure, for example, limiting the service capability referenced by the user or extending the capacity of the forwarding server, wherein the limiting the service capability referenced by the user may be stopping the timed task generated currently, that is, stopping executing an SLB strategy not meeting the load balancing capacity in a corresponding time period, and adjusting the SLB strategy a 302ccording to the actual situation to generate a new timed task to meet the requirement.

For example, the acquisition apparatus 110 further includes: a first update unit (not shown in FIG. 2) and a second update unit (not shown in FIG. 2), wherein, the first update unit, when the request time period and the execution time period of the existing timed task have an overlapped time period, updates the execution time period of the existing timed task based on the overlapped time period; and the second update unit updates the existing timed task based on the updated execution time period, wherein the timed task is a timed task executed once or a timed task executed periodically and circularly.

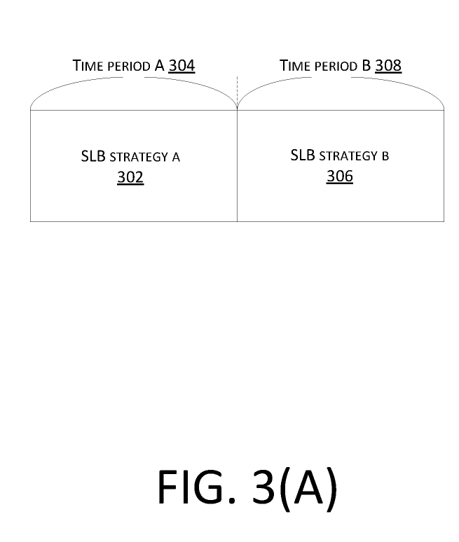

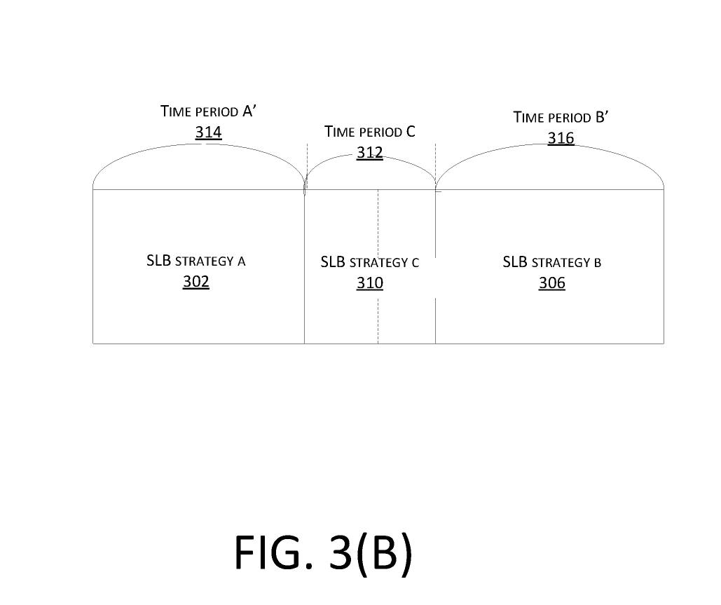

In a specific example embodiment, for example, in an existing timed task and a strategy in a corresponding time period shown in FIG. 3(a), a strategy a 302 is executed in a time period A 304, and a strategy b 306 is executed in a time period B 308. When the user suddenly has a requirement, for example, the requirement of executing a strategy c 310 in a time period C 312, as shown in FIG. 3(b), one part of the time period C 312 belongs to the time period A 304 and the other part belongs to the time period B 308, and an overlapped time period exists; in this case, the execution time period of the existing timed task needs to be updated, that is, the originally executing the SLB strategy a 302 in the time period A 304 and executing the SLB strategy b 304 in the time period B 308 is updated to executing the SLB strategy a 302 in a time period A′ 314, executing the SLB strategy c 310 in the next time period C 312, and executing the SLB strategy b 304 in the following time period B′ 316. It can be seen that the execution time periods of the timed tasks corresponding to the strategy a and the strategy b are changed, and in this way, according to the selection request of the user, the SLB strategies needed by the user are configured flexibly, such that the load balancing is more flexible and more adapted to different environments, thereby extending the applicability of the load balancing. In addition, the existing timed task is updated according to the updated time period. For example, the timed task of the strategy a 302 is executed once in the time period A′ 314, and the strategy c 310 is executed circularly in the time period C 312.

For example, the execution apparatus 112, when the execution time period corresponding to the timed task ends, deletes the existing load balancing method and acquire a load balancing method corresponding to the next execution time period.

Herein, a timed task corresponding to a time period is acquired at a time point when the time period starts, the timed task is ended at a time point when the time period ends, a corresponding SLB strategy in the time period is deleted, and a corresponding SLB strategy in the next execution time period is acquired. For example, in a specific example embodiment, the user needs to increase the bandwidth in March, then, an SLB strategy 1 is executed before March, the previous SLB strategy 1 is deleted when March starts and an SLB strategy 2 corresponding to March is acquired, that is, a load balancing strategy of the time period of March is adjusted, such that the configuration of the user is flexible.

For example, the timed task includes any of the following: a periodically and circularly executed timed task; a timed task executed once; and a timed task coordinating the timed task executed once and the periodically with circularly executed timed task.

For example, the time-based SLB strategy may be created in the following manners:

1) Strategies circulating according to time periods, for example, SLB strategies within 24 hours are defined by using one day as a unit, and these strategies circulate every day; or SLB strategies within 7*24 hours are defined by using one week as a unit, and these strategies circulate every week; or SLB strategies within 30 days are defined by using one month as a unit, and these strategies circulate every month. The acquisition apparatus 110 acquires time period information that needs to be circulated periodically and corresponding SLB strategies, and then generates corresponding timed tasks, wherein the timed tasks are executed periodically and circularly according to the requirement. It should be noted that, the manner of creating strategies circulating according to time periods is merely an example, the corresponding SLB strategies may be circulated by using any unit of time as a circulation time period, and other existing or future possible timed tasks executed periodically and circularly, if applicable to the present disclosure, should also be included in the protection scope of the present disclosure, and be incorporated herein by reference.

2) Each time period has a different strategy, different SLB strategies are corresponding to different time periods, and the strategy in a time period does not circulate. That is, after the time period information and corresponding SLB strategies are acquired, a timed task corresponding to a time period is generated, a corresponding strategy is deleted when the time period ends, and the strategy in the time period is not executed circularly. For example, in a specific scenario, a time period from 9:00 to 17:00 is working time, and bandwidth needs to be increased, so that an SLB strategy 2 is used; in a time period from 22:00 to 06:00 of the next day, the bandwidth needs to be decreased, so that an SLB strategy 3 is used, and a strategy 1 is executed in other time periods; therefore, time tasks generated are all executed once, that is, a corresponding timed task is ended after the strategy 2 is executed in the time period from 9:00 to 17:00, and a corresponding timed task is ended after the strategy 3 is executed in the time period from 22:00 to 06:00 of the next day. For another example, when the user makes a payment, a bill is generated in the limit of a month, and the user needs to select a fixed bandwidth in the first time period of a month due to some reasons, and use the traffic-based charging method in the rest time period; therefore, according to the requirement of the user, a timed task a is executed once in the first time period, and here the timed task a is a strategy of charging according to a fixed bandwidth in the first time period, the charging manner is changed when the time period ends, a timed task b is also executed once in the rest time period, and here, the timed task b refers to a strategy of charging according to traffic in the rest time period, the timed task b is stopped when the time period ends, the strategy of charging according to traffic is deleted, and a new time period and a strategy corresponding to the time period are acquired.

3) A combined strategy is created, wherein different strategies are used in different time periods, and a circularly executed strategy may also be defined in a time period. For example, the user needs a big promotion of traffic in a month (for example, in November), a large bandwidth is set in this month, a strategy a is executed in other months, and a strategy b is executed in the time period of November to increase the bandwidth. However, in the time period of this month, a circular strategy may also be defined, according to different bandwidth amounts required in different time periods, for example, a strategy b′1 is executed in daytime periods of this month, and a strategy b′2 is executed in night time periods. The timed task coordinating the timed task executed once with the periodically and circularly executed timed task is implemented according to the selection request of the user.

It should be noted that, in the above example embodiment, when multiple SLB strategies selected by the user are acquired and then the load balancing is adjusted for service, it should be met that a sum of service capacities referenced by strategies used by all users cannot exceed the service capability of the forwarding server, and if the sum exceeds the service capability of the forwarding server, it is necessary to make an alarm and send notification information to take a corresponding measure.

Those skilled in the art should understand that the creation manner of a time-based SLB strategy is merely an example, and other existing or future possible creation manners, if applicable to the present disclosure, should also be included in the protection scope of the present disclosure, and be incorporated herein by reference.

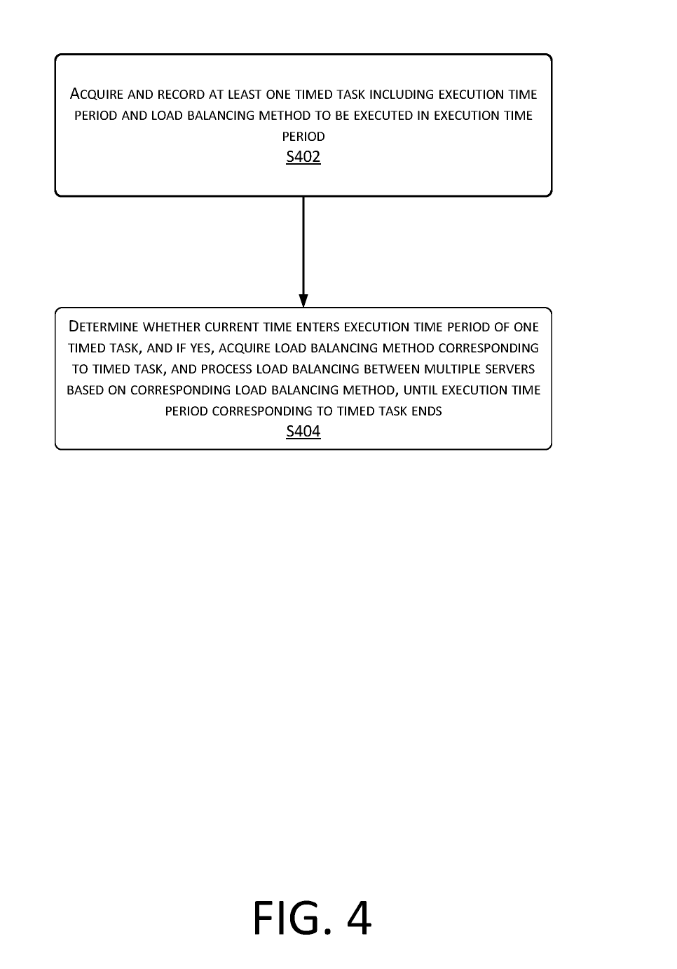

FIG. 4 is a schematic flow chart of a time-based adjustable load balancing method according to another aspect of the present disclosure. The method includes step S402 and step S404, wherein, in step S402, at least one timed task is acquired and recorded, wherein the timed task includes an execution time period and a load balancing method to be executed in the execution time period; and in step S404, it is determined whether a current time enters an execution time period of one timed task, and if yes, the load balancing method corresponding to the timed task is acquired, and load balancing between multiple servers is processed based on the corresponding load balancing method, till the execution time period corresponding to the timed task ends.

The time-based adjustable load balancing method according to an example embodiment of the present disclosure enables that a corresponding load balancing method is executed in an execution time period of a request according to the request of the user, thereby implementing flexible configuration of the user to meet the requirement of the user, and meanwhile increasing the applicability of load balancing.

Those skilled in the art should understand that, in a specific solution implementation, the load balancing strategy is used to select, according to an access request of the user, a back-end server according to a correspondingly made load balancing strategy to process the request, and for ease of description, the load balancing method and the load balancing strategy (SLB strategy) are exchanged for use in the example embodiment.

Specifically, in step S402, at least one timed task is acquired and recorded, wherein the timed task includes an execution time period and a load balancing method to be executed in the execution time period.

Here, a Server Load Balancer (SLB) is a load balancing service for distributing traffic for multiple cloud servers, and the load balancing may extend external service capability of an application system by traffic distribution, and improve the usability of the application system by eliminating single point of failure. In an example embodiment of the present disclosure, the SLB controller delivers the SLB strategy to an SLB forwarding server. To implement a time-based strategy, a time server needs to be created on the SLB controller, all strategies relevant to time may be sent to the time server, and the time server delivers a corresponding forwarding strategy to the forwarding server according to the time strategy. It should be noted that, in the above example embodiment, a time server is created in step S402, and the time server implements a timed task executed once and a timed task executed circularly, wherein the timed task is executing, in a time period, a to-be-executed load balancing strategy selected by the user. At least one timed task is generated by acquiring time period information of the user request and information of SLB strategy to be executed in the time period, and a corresponding SLB strategy is executed in the time period of the request based on the timed task. For example, the user selects, according to a traffic use condition thereof, an SLB strategy a 302 in a time period from 06:00 to 18:00, selects an SLB strategy b 304 in a time period from 18:00 to 06:00 of the next day, request information of the selected time period and information of the SLB strategy executed in the corresponding time period are sent to the time server, and two timed tasks are generated. A timed task a is used for the time server to execute the SLB strategy a 302 in the time period from 06:00 to 18:00, and the timed task b is used for the time server to execute the SLB strategy b 304 in the time period from 18:00 to 06:00 of the next day.

Those skilled in the art should understand that the method of acquiring and recording a timed task is merely an example, and other existing or future possible methods of acquiring and recording a timed task, if applicable to the present disclosure, should also be included in the protection scope of the present disclosure, and be incorporated herein by reference.

Specifically, in step S404, it is determined whether a current time enters an execution time period of one timed task, and if yes, the load balancing method corresponding to the timed task is acquired, and load balancing between multiple servers is processed based on the corresponding load balancing method, till the execution time period corresponding to the timed task ends.

According to the foregoing example, after the user selects, according to the traffic use condition thereof, the SLB strategy a 302 in the time period from 06:00 to 18:00 and selects the SLB strategy b 304 in the time period from 18:00 to 06:00 of the next day, the time server acquires the request information of the time period selected by the user and information of the SLB strategy executed in the corresponding time period, forwards the acquired information to the forwarding server according to the forwarding strategy, thereby implementing load balancing between multiple servers. When multiple timed tasks are executed, it is needed to determine whether the current time enters a selected time period, and if the current time belongs to the time period from 06:00 to 18:00, the SLB strategy a 302 is executed and ends till the time point 18:00, then the next time period from 18:00 to 06:00 of the next day is entered, and the SLB strategy b 304 is always executed in this time period till the timed task b corresponding to the time period ends.

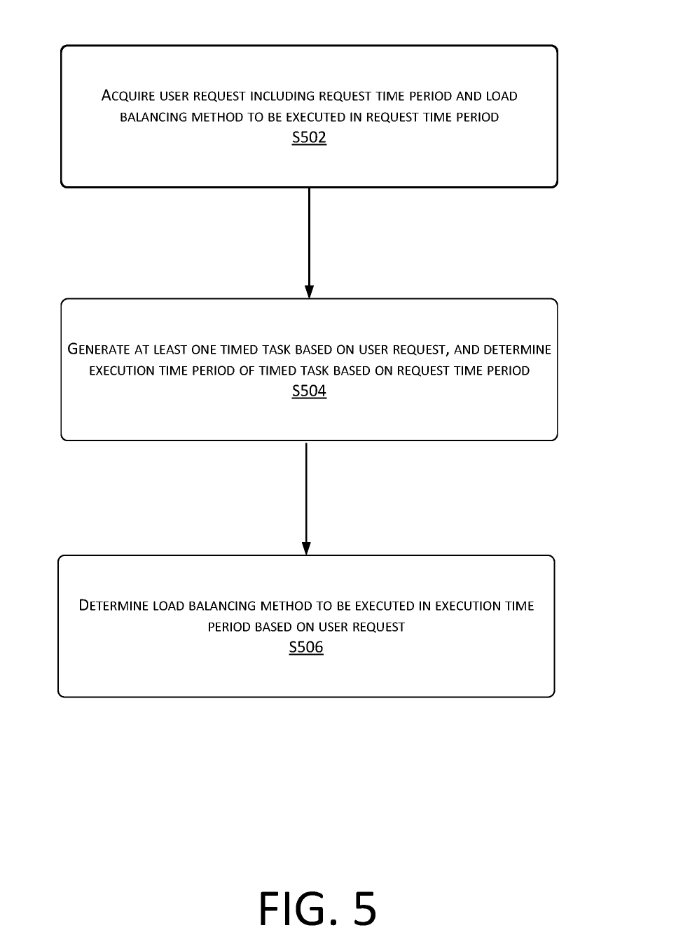

For example, FIG. 5 is a schematic flow chart of a method of step S402 in an example embodiment according to another aspect of the present disclosure. The step S402 includes: step S502, step S504, and step S506. Wherein, in step S502, a user request is acquired, wherein the user request includes a request time period and a load balancing method to be executed in the request time period; then, in step S504, at least one timed task is generated based on the user request, and an execution time period of the timed task is determined based on the request time period; and finally, in step S506, a load balancing method to be executed in the execution time period is determined based on the user request.

In a specific example embodiment, in step S502, information of the time period selected by the user and information of an SLB strategy to be used in the time period are acquired; then step S504 is performed, wherein a corresponding timed task according to the acquired request information is generated, and a time period of executing the timed task is determined; then, step S506 is performed to determine that the SLB strategy needed by the user is executed in the execution time period, that is, a corresponding SLB strategy is executed in each time period, an SLB strategy is added when time of the time period starts, the SLB strategy is deleted when the time point ends, and a new strategy is added again when the next time period is entered and then is executed, such that flexible configuration of the user is completed according to the requirement of the user.

For example, the step S506 includes: determining, based on the user request, performance parameter information of load balancing; and determining, based on the performance parameter information of load balancing, a load balancing method to be executed in the execution time period.

For example, the performance parameter information includes at least one of the following: bandwidth amount, the number of creatable connections, and the number of new creatable connections per second. For example, the user wants promotion in a month, and requires that the bandwidth is increased in this month, the required bandwidth is changed to B from the previous A, according to the request of the user, it is determined that an SLB strategy of distributing bandwidth B to the user in this month and distributing the bandwidth A in the time period of other months is executed; for another example, a server of an enterprise needs to adjust, in a time period, the number of personal computers (PCs) that can create connections, and an SLB strategy in the required time period is determined according to the request of the number of creatable connections. Alternatively, a corresponding adjusted SLB strategy is determined according to the request of the number of new creatable connections per second required by the server. It should be noted that, the bandwidth amount, the number of creatable connections, and the number of new creatable connections per second are resources provided by the load balancing to the external, and may be used as SLB performance parameters owned by the user. Resources distributed by the load balancing to the user server are adjusted by the SLB strategy created based on time, thus meeting the requirement of the user for using the SLB. For example, the bandwidth is increased when the traffic of the user is large, and the bandwidth is decreased when the traffic of the user is small, and such a flexible strategy saves cost of the user.

For example, the step S506 further includes: when the acquired performance parameter information of load balancing exceeds performance parameter information of existing service capability of the load balancing, stopping generating the timed task, and returning alarm notification information.

Herein, determining the service capability of the load balancing is based on the capacity of the forwarding server and a service capability referenced by the strategy of executing the timed task, for example, the performance parameters such as bandwidth, the number of creatable connections, and the number of new creatable connections per second. If a sum of service capabilities referenced by SLB strategies selected by all users exceeds the capacity of the forwarding server, an alarm is given to notify an administrator of taking a corresponding measure, for example, limiting the service capability referenced by the user or extending the capacity of the forwarding server, wherein the limiting the service capability referenced by the user may be stopping the timed task generated currently, that is, stopping executing an SLB strategy not meeting the load balancing capacity in a corresponding time period, and adjusting the SLB strategy according to the actual situation to generate a new timed task to meet the requirement.

For example, the step S402 further includes: when the request time period and the execution time period of the existing timed task have an overlapped time period, updating the execution time period of the existing timed task based on the overlapped time period; and then updating the existing timed task based on the updated execution time period, wherein the timed task is a timed task executed for once or a timed task executed periodically and circularly.

In a specific example embodiment, for example, in an existing timed task and a strategy in a corresponding time period shown in FIG. 3(a), a strategy a 302 is executed in a time period A 304, and a strategy b 306 is executed in a time period B 308. When the user suddenly has a requirement, for example, the requirement of executing a strategy c 310 in a time period C 312, as shown in FIG. 3(b), one part of the time period C 312 belongs to the time period A 304 and the other part belongs to the time period B 308, and an overlapped time period exists; in this case, the execution time period of the existing timed task needs to be updated, that is, the originally executing the SLB strategy a 302 in the time period A 304 and executing the SLB strategy b 304 in the time period B 308 is updated to executing the SLB strategy a 302 in a time period A′ 314, executing the SLB strategy c 310 in the next time period C 312, and executing the SLB strategy b 304 in the following time period B′ 316. It can be seen that, the execution time periods of the timed tasks corresponding to the strategy a and the strategy b are changed, and in this way, according to the selection request of the user, the SLB strategies needed by the user are configured flexibly, such that the load balancing is more flexible and more adapted to different environments, thereby extending the applicability of the load balancing. In addition, the existing timed task is updated according to the updated time period. For example, the timed task of the strategy a 302 is executed once in the time period A′ 314, and the strategy c 310 is executed circularly in the time period C 312.

For example, the step S404 includes: when the execution time period corresponding to the timed task ends, deleting the existing load balancing method and acquiring a load balancing method corresponding to the next execution time period.

Herein, a timed task corresponding to a time period is acquired at a time point when the time period starts, the timed task is ended at a time point when the time period ends, a corresponding SLB strategy in the time period is deleted, and a corresponding SLB strategy in the next execution time period is acquired. For example, in a specific example embodiment, the user needs to increase the bandwidth in March, then, an SLB strategy 1 is executed before March, the previous SLB strategy 1 is deleted when March starts and an SLB strategy 2 corresponding to March is acquired, that is, a load balancing strategy of the time period of March is adjusted, such that the configuration of the user is flexible.

For example, the timed task includes any of the following: a periodically and circularly executed timed task; a timed task executed once; and a timed task coordinating the timed task executed once with the periodically and circularly executed timed task.

For example, the time-based SLB strategy may be created in the following manners:

1) Strategies circulating according to time periods, for example, SLB strategies within 24 hours are defined by using one day as a unit, and these strategies circulate every day; or SLB strategies within 7*24 hours are defined by using one week as a unit, and these strategies circulate every week; or SLB strategies within 30 days are defined by using one month as a unit, and these strategies circulate every month. The acquisition apparatus 110 acquires time period information that needs to be circulated periodically and corresponding SLB strategies, and then generates corresponding timed tasks, wherein the timed tasks are executed periodically and circularly according to the requirement. It should be noted that, the manner of creating strategies circulating according to time periods is merely an example, the corresponding SLB strategies may be circulated by using any unit of time as a circulation time, and other existing or future possible timed tasks executed periodically and circularly, if applicable to the present disclosure, should also be included in the protection scope of the present disclosure, and be incorporated herein by reference.

2) Each time period has a different strategy, different SLB strategies are corresponding to different time periods, and the strategy in a time period does not circulate. That is, after the time period information and corresponding SLB strategies are acquired, a timed task corresponding to a time period is generated, a corresponding strategy is deleted when the time period ends, and the strategy in the time period is not executed circularly. For example, in a specific scenario, a time period from 9:00 to 17:00 is working time, and bandwidth needs to be increased, so that an SLB strategy 2 is used; in a time period from 22:00 to 06:00 of the next day, the bandwidth needs to be decreased, so that an SLB strategy 3 is used, and a strategy 1 is executed in other time periods; therefore, time tasks generated are all executed once, that is, a corresponding timed task is ended after the strategy 2 is executed in the time period from 9:00 to 17:00, and a corresponding timed task is ended after the strategy 3 is executed in the time period from 22:00 to 06:00 of the next day. For another example, when the user makes a payment, a bill is generated in the limit of a month, and the user needs to select a fixed bandwidth in the first time period of a month due to some reasons, and use the traffic-based charging method in the rest time period; therefore, according to the requirement of the user, a timed task a is executed once in the first time period, and here the timed task a is a strategy of charging according to a fixed bandwidth in the first time period, the charging manner is changed when the time period ends, a timed task b is also executed once in the rest time period, and here, the timed task b refers to a strategy of charging according to traffic in the rest time period, the timed task b is stopped when the time period ends, the strategy of charging according to traffic is deleted, and a new time period and a strategy corresponding to the time period are acquired.

3) A combined strategy is created, wherein different strategies are used in different time periods, and a circularly executed strategy may also be defined in a time period. For example, the user needs a big promotion of traffic in a month (for example, in November), a large bandwidth is set in this month, a strategy a is executed in other months, and a strategy b is executed in the time period of November to increase the bandwidth. However, in the time period of this month, a circular strategy may also be defined, according to different bandwidth amounts required in different time periods, for example, a strategy b′1 is executed in daytime periods of this month, and a strategy b′2 is executed in night time periods. The timed task coordinating the timed task executed once with the periodically and circularly executed timed task is implemented according to the selection request of the user.

It should be noted that, in the above example embodiment, when multiple SLB strategies selected by the user are acquired and then the load balancing is adjusted for service, it should be met that a sum of service capacities referenced by strategies used by all users cannot exceed the service capability of the forwarding server, and if the sum exceeds the service capability of the forwarding server, it is necessary to make an alarm and send notification information to take a corresponding measure.

Those skilled in the art should understand that the creation manner of a time-based SLB strategy is merely an example, and other existing or future possible creation manners, if applicable to the present disclosure, should also be included in the protection scope of the present disclosure, and be incorporated herein by reference.

It should be noted that the present disclosure may be implemented in software and/or a combination of software and hardware, for example, an application specific integrated circuit (ASIC), a general-purpose computer or any other similar hardware devices can be used for implementing the present disclosure. In one example embodiment, a software program of the present disclosure may be executed by a processor to achieve the steps or functions described above. Similarly, the software program (including a related data structure) of the present disclosure can be stored into a computer readable recording medium, for example, a RAM memory, a magnetic or optical drive or a floppy disk and similar devices. In addition, some steps or functions of the present disclosure may be implemented with hardware, for example, a circuit that performs various steps or functions in cooperation with the processor.

In addition, a part of the present disclosure can be applied as a computer program product, for example, a computer program instruction, and when it is executed by a computer, the method and/or the technical solution according to the present disclosure can be called or provided through operations of the computer. The program instruction that calls the method of the present disclosure may be stored in a fixed or removable recording medium, and/or transmitted by means of broadcast or data streams in other signal carrying media, and/or stored in a working memory of a computer device that runs according to the program instruction. Herein, an example embodiment according to the present disclosure includes an apparatus, the apparatus including a memory configured to store a computer program instruction and a processor configured to execute the program instruction, wherein, when the computer program instruction is executed by the processor, the apparatus is triggered to run the method and/or the technical solution based on the multiple example embodiments of the present disclosure.

For those skilled in the art, it is apparent that the present disclosure is not limited to the details of the foregoing exemplary example embodiments, and the present disclosure can be implemented in other specific forms without departing from the spirit or basic features of the present disclosure. Therefore, from whichever perspective, the example embodiments are regarded as exemplary instead of being restrictive, the scope of the present disclosure is defined by the appended claims instead of the above description, and thus the present disclosure is intended to cover all changes falling in the meaning and scope of the equivalent elements of the claims. None of the reference signs in the claims should be regarded as limiting the involved claims. In addition, it is apparent that the wording “include” does not exclude other units or steps, and the singular form does not exclude the plural form. Multiple units or apparatuses stated in the apparatus claims may also be implemented by one unit or apparatus through software or hardware. Terms such as “first” and “second” are used to represent names, but do not indicate any specific order.

What is claimed is:

1. A method comprising:
acquiring a timed task, the timed task including an execution time period and a load balancing method to be executed in the execution time period;
determining that a current time enters into the execution time period;
acquiring the load balancing method corresponding to the timed task; and
processing load balancing between multiple servers based on the load balancing method corresponding to the timed task until the execution time period corresponding to the timed task ends.

2. The method of claim 1, wherein the acquiring the timed task includes:
acquiring a user request, the user request including a request time period and a load balancing method to be executed in the request time period;
generating the timed task based on the user request;
determining the execution time period of the timed task based on the request time period; and
determining, based on the user request, the load balancing method to be executed in the execution time period.

3. The method of claim 2, wherein the determining, based on the user request, the load balancing method to be executed in the execution time period includes:
acquiring performance parameter information of load balancing based on the user request; and
determining, based on the performance parameter information of load balancing, the load balancing method to be executed in the execution time period.

4. The method of claim 3, wherein the performance parameter information includes a bandwidth amount.

5. The method of claim 3, wherein the performance parameter information includes a number of creatable connections.

6. The method of claim 3, wherein the performance parameter information includes a number of new creatable connections per second.

7. The method of claim 3, wherein the determining, based on the user request, the load balancing method to be executed in the execution time period includes:
stopping generating the timed task when the acquired performance parameter information of load balancing exceeds performance parameter information of existing service capability of the load balancing, and
returning alarm notification information.

8. The method of claim 2, wherein the acquiring the timed task further includes:
updating the execution time period of the timed task based on an overlapped time period when the request time period and the execution time period have the overlapped time period; and
updating the timed task based on the updated execution time period.

9. The method of claim 1, further comprising:
deleting the load balancing method and acquiring a next load balancing method corresponding to a next execution time period, when the execution time period corresponding to the timed task ends.

10. The method of claim 1, wherein the timed task includes any of the following:
a first timed task executed periodically and circularly;
a second timed task executed once; and
a third timed task coordinating the first timed task executed once with the second timed task executed periodically and circularly.

11. A device comprising:
an acquisition apparatus that acquire and records a timed task, the timed task including an execution time period and a load balancing method to be executed in the execution time period; and
an execution apparatus that determines that a current time enters into the execution time period, acquires the load balancing method corresponding to the timed task, and processes load balancing between multiple servers based on the load balancing method corresponding to the timed task until the execution time period corresponding to the timed task ends.

12. The device of claim 11, wherein the acquisition apparatus includes:
a request acquisition unit that acquires a user request, the user request including a request time period and a load balancing method to be executed in the request time period;
a generation unit that generates the timed task based on the user request and determines the execution time period of the timed task based on the request time period; and
a determination unit that determines, based on the user request, the load balancing method to be executed in the execution time period.

13. The device of claim 12, wherein the determination unit further:
acquires performance parameter information of load balancing based on the user request; and
determines, based on the performance parameter information of load balancing, the load balancing method to be executed in the execution time period.

14. The device of claim 13, wherein the performance parameter information includes at least one of the following:
a bandwidth amount;
a number of creatable connections; and
a number of new creatable connections per second.

15. The device of claim 12, wherein the determination unit further:
stops generating the timed task when the acquired performance parameter information of load balancing exceeds performance parameter information of existing service capability of the load balancing, and
returns alarm notification information.

16. The device of claim 11, wherein the acquisition apparatus includes:
a first update unit that updates the execution time period of the existing timed task based on the overlapped time period when the request time period and the execution time period of the existing timed task have an overlapped time period.

17. The device of claim 16, wherein the acquisition apparatus further includes:
a second update unit that updates the existing timed task based on the updated execution time period, wherein the timed task is a timed task executed once or a timed task executed periodically and circularly.

18. The device of claim 11, wherein the execution apparatus further:
deletes the load balancing method and acquiring a next load balancing method corresponding to a next execution time period, when the execution time period corresponding to the timed task ends.

19. The device of claim 11, wherein the timed task comprises any of the following:
a first timed task executed periodically and circularly;
a second timed task executed once; and
a third timed task coordinating the first timed task executed once with the second timed task executed periodically and circularly.

20. One or more memories stored thereon computer-executable instructions that, when executed by one or more processors, cause the processor to perform acts comprising:
acquiring a timed task, the timed task including an execution time period and a load balancing method to be executed in the execution time period;
determining that a current time enters into the execution time period;
acquiring the load balancing method corresponding to the timed task; and
processing load balancing between multiple servers based on the load balancing method corresponding to the timed task until the execution time period corresponding to the timed task ends.
